(19) United States
(12) Patent Application Publication
(10) Pub. No.: US 2026/0204499 A1
(43) Pub. Date: Jul. 16, 2026

(54) CIRCUIT BREAKER AND PHOTOVOLTAIC SYSTEM

(71) Applicant: Huawei Digital Power Technologies Co., Ltd., Shenzhen (CN)

(72) Inventors: Xiaoke Ran, Dongguan (CN); Jisheng Sun, Shanghai (CN); Xiufeng Zhang, Dongguan (CN); Fugao Zhao, Dongguan (CN); Quanfei Xia, Dongguan (CN); Yawen Gong, Dongguan (CN); Xin Gui, Shanghai (CN)

(73) Assignee: Huawei Digital Power Technologies Co., Ltd., Shenzhen (CN)

(21) Appl. No.: 19/565,086

(22) Filed: Mar. 12, 2026

Related U.S. Application Data
(63) Continuation of application No. PCT/CN2024/120382, filed on Sep. 23, 2024.

(30) Foreign Application Priority Data
Oct. 12, 2023 (CN) 202322752116.8

(51) Int. Cl. H01H 33/08

(52) U.S. Cl. CPC H01H 33/08

(57) ABSTRACT

A circuit breaker includes a housing, a busbar, a detonation assembly, and an arc extinguishing assembly. The busbar passes through the housing and is partially located between the arc extinguishing chamber and the detonation chamber; and the detonation assembly is configured to explode and break the busbar when a current flowing through the busbar is greater than a safety threshold, to implement a circuit disconnection function. The arc extinguishing assembly includes a plurality of arc extinguishing grid plates and a first arc guiding member. A first end of the first arc guiding member includes a first structure end, the first structure end is in conductive contact with the busbar, and a second end of the first arc guiding member extends to the first arc extinguishing grid plate that is along an extension direction of the busbar among the plurality of arc extinguishing grid plates.

### CROSS-REFERENCE TO RELATED APPLICATIONS

This application is a continuation of International Application No. PCT/CN2024/120382, filed on Sep. 23, 2024, which claims priority to Chinese Patent Application No. 202322752116.8, filed on Oct. 12, 2023. The disclosures of the aforementioned applications are hereby incorporated by reference in their entireties.

### TECHNICAL FIELD

This application relates to the field of electrical equipment technologies, and in particular, to a circuit breaker and a photovoltaic system.

### BACKGROUND

In the field of electrical equipment, a switch device undertakes a function of conducting electricity under a normal loop condition and disconnecting a circuit under an abnormal loop condition. The switch device herein includes but is not limited to a circuit breaker, a fuse, and the like. When the switch device is disconnected, a separation action of a contact is usually accompanied by generation of an arc, and the arc causes specific damage to the switch device. Therefore, a measure needs to be taken to extinguish the arc in time.

In a distribution system with a high voltage, a current switch device cannot adequately meet requirements of fast power-off and safety.

### SUMMARY

Embodiments of this disclosure provide a circuit breaker and a photovoltaic system. The circuit breaker can be applied to an alternating current or direct current distribution network with a high voltage; and can quickly extinguish an arc when a busbar is broken, to protect a device.

According to a first aspect, a circuit breaker that can be used in a photovoltaic system is provided, to quickly extinguish an arc when a busbar is broken and the arc is generated. The circuit breaker includes a housing, the busbar, a detonation assembly, and an arc extinguishing assembly. The housing includes an arc extinguishing chamber and a detonation chamber that communicate with each other, the arc extinguishing assembly is accommodated in the arc extinguishing chamber, and the detonation assembly is accommodated in the detonation chamber. The busbar passes through the housing and is at least partially located between the arc extinguishing chamber and the detonation chamber; and the detonation assembly is configured to explode and break the busbar when a current flowing through the busbar is greater than a safety threshold, to implement a circuit disconnection function. The arc extinguishing assembly includes a plurality of arc extinguishing grid plates and a first arc guiding member. The plurality of arc extinguishing grid plates are arranged at intervals along an extension direction of the busbar, and any two adjacent arc extinguishing grid plates are disposed in an insulated manner. The first arc guiding member is fastened to the busbar. Along the extension direction of the busbar, a first end of the first arc guiding member includes a first structure end, the first structure end is in conductive contact with the busbar, and a second end of the first arc guiding member extends to the first arc extinguishing grid plate that is along the extension direction of the busbar among the plurality of arc extinguishing grid plates. When the busbar is broken and the arc is generated, under pulling of the first arc guiding member, an arc root of the arc guides the second end of the first arc guiding member to the first arc extinguishing grid plate, so that the arc enters between the plurality of arc extinguishing grid plates, and the plurality of arc extinguishing grid plates can quickly extinguish the arc. The first arc guiding member of the circuit breaker can provide, through the first structure end and a second structure end, two arc guiding paths for the arc formed by breakage of the busbar, to guide the arc to the arc extinguishing assembly more quickly and reliably, so that arc extinguishing effect is ensured, and alternating current or direct current arc extinguishing at a high voltage can be implemented.

In an embodiment, the arc extinguishing assembly includes a second arc guiding member, a first end of the second arc guiding member includes a first structure end, the first structure end is in conductive contact with the busbar, and the second end of the first arc guiding member extends to the last arc extinguishing grid plate that is along the extension direction of the busbar among the plurality of arc extinguishing grid plates. A structure of the second arc guiding member is similar to a structure of the first arc guiding member, and it is equivalent to that two arc guiding members are disposed in the arc extinguishing assembly. The first arc guiding member can guide one end of the arc formed between two breaks of the busbar to the first arc extinguishing grid plate, and the second arc guiding member can guide the other end of the arc to the last arc extinguishing grid plate, to implement fast arc guiding and arc distinguishing.

Specifically, the first structure end includes a contact surface facing away from the plurality of arc extinguishing grid plates, and the contact surface is parallel to the extension direction of the busbar. The contact surface is configured to be in surface contact with the busbar, to achieve reliable connection effect.

In an embodiment, the first end of the first arc guiding member further includes the second structure end, the second structure end is bent in a direction close to the arc extinguishing grid plate, and an extension direction of the second structure end is set at an acute clockwise angle to the busbar. The second structure end can be closer to the break of the busbar after the busbar is broken, and after the busbar is broken, the arc formed between the breaks can be captured by the second structure end in time.

Specifically, the first arc guiding member includes an arc guiding section, an extension section, and a directional section that are integrally connected, and the extension section is connected between the arc guiding section and the directional section. An end that is of the arc guiding section and that is away from the extension section is the first end of the first arc guiding member, and an end that is of the directional section and that is away from the extension section is the second end of the first arc guiding member. The extension section is parallel to the extension direction of the busbar, to guide the arc root of the arc to the directional section. The directional section extends in a direction of the first arc extinguishing grid plate away from the busbar, to guide the arc root of the arc to a bottom of the arc extinguishing grid plate, so that the arc can enter as deep as possible between the plurality of arc extinguishing grid plates.

In an embodiment, a part of arc extinguishing grid plates are disposed at an acute clockwise angle to the busbar, and the other part of arc extinguishing grid plates are disposed at an obtuse clockwise angle to the busbar. Along the extension direction of the busbar, a distance between an end part that is of the first arc extinguishing grid plate and that faces the busbar and an end part that is of the last arc extinguishing grid plate and that faces the busbar is less than a distance between an end part that is of the first arc extinguishing grid plate and that is away from the busbar and an end part that is of the last arc extinguishing grid plate and that is away from the busbar. The arc extinguishing grid plate disposed in an inclined manner helps guide and exhaust high-pressure gas generated during arc extinguishing. In addition, the arc extinguishing grid plate disposed in the inclined manner can further elongate, interrupt, and extinguish the arc, to achieve better arc extinguishing effect.

In an embodiment, along the extension direction of the busbar, in any two adjacent arc extinguishing grid plates, a distance between end parts that are of the two arc extinguishing grid plates and that face the busbar is less than a distance between end parts that are of the two arc extinguishing grid plates and that are away from the busbar, to further elongate the arc and optimize the arc extinguishing effect.

In an embodiment, the housing includes an outer housing and a plurality of inner housings. The plurality of inner housings are accommodated in the outer housing, each inner housing encloses to form one arc extinguishing chamber, and one arc extinguishing assembly and one busbar are correspondingly disposed for each arc extinguishing chamber. Each arc extinguishing assembly corresponds to one busbar to form a modular structure, and different arc extinguishing assemblies can be combined in design, so that a structure is simpler, and automated assembly is easily implemented.

In an embodiment, the housing includes at least one detonation housing. Each detonation housing is fastened to the outer housing, each detonation encloses to form one detonation chamber, and each detonation chamber communicates with at least one arc extinguishing chamber. There is at least one detonation housing, and a detonation assembly in a detonation chamber of each detonation housing can correspondingly explode and break one or more busbars.

In an embodiment, the housing includes at least one exhaust vent and a plurality of air passages, each exhaust vent communicates with the outside, the plurality of air passages are provided in a distributed manner, and each air passage communicates with the arc extinguishing chamber and the at least one exhaust vent. The arc extinguishing assembly generates high-temperature and high-pressure gas in an arc extinguishing process, and the gas can be more evenly guided to the at least one exhaust vent through the plurality of air passages for exhaust.

In an embodiment, the busbar includes a breakable part and two fastening parts, and the breakable part is located between the two fastening parts and is integrally connected to the two fastening parts. The two fastening parts are separately fastened to the housing, the breakable part is located between the arc extinguishing chamber and the detonation chamber, and structural strength of the breakable part is less than structural strength of the fastening part, so that the breakable part of the busbar can be broken when the detonation assembly explodes, to implement the circuit disconnection function.

According to a second aspect, a photovoltaic system is provided. The system includes a circuit breaker and an inverter. A direct current input of the inverter is configured to connect to a photovoltaic module, an alternating current output of the inverter is connected to the circuit breaker, and the circuit breaker is configured to connect to a load. The load may be a power grid, or may be an electric device, an energy storage device, or the like.

For technical effect that can be achieved in the second aspect, refer to the descriptions of the technical effect that can be achieved in the corresponding design solutions in the first aspect. Details are not described herein again in this disclosure.

### BRIEF DESCRIPTION OF DRAWINGS

FIG. 1 is a diagram of a structure of a photovoltaic system according to an embodiment of this disclosure;

FIG. 2 is a diagram of a cross-sectional structure of a circuit breaker according to an embodiment of this disclosure;

FIG. 3a is a diagram of structures of an inner housing and a busbar of a circuit breaker according to an embodiment of this disclosure;

FIG. 3b is an exploded view of a part of structures of an inner housing and a busbar of a circuit breaker according to an embodiment of this disclosure;

FIG. 4a is a diagram of a structure of a busbar of a circuit breaker according to an embodiment of this disclosure;

FIG. 4b is a diagram of a structure of a busbar of a circuit breaker along a Y direction according to an embodiment of this disclosure;

FIG. 4c is a diagram of a structure of a busbar of a circuit breaker when the busbar is broken by impact according to an embodiment of this disclosure;

FIG. 5a is a diagram of cross-sectional structures of an inner housing and a busbar according to an embodiment of this disclosure;

FIG. 5b is a diagram of a structure of an arc extinguishing unit of an arc extinguishing assembly according to an embodiment of this disclosure;

FIG. 5c is a diagram of a structure of an arc extinguishing unit of an arc extinguishing assembly along a Y direction according to an embodiment of this disclosure;

FIG. 5d is a diagram of a structure of an arc extinguishing unit of an arc extinguishing assembly along a Y direction according to an embodiment of this disclosure;

FIG. 6a is a diagram of a structure of an arc guiding member of an arc extinguishing assembly according to an embodiment of this disclosure;

FIG. 6b is a diagram of a part of structures of an arc extinguishing assembly and a busbar according to an embodiment of this disclosure;

FIG. 6c is a diagram of an arc extinguishing principle of an arc extinguishing assembly according to an embodiment of this disclosure;

FIG. 7a is a diagram of a structure of a circuit breaker along aY direction when the circuit breaker works normally according to an embodiment of this disclosure; and

FIG. 7b is a diagram of a structure of a circuit breaker along aY direction when the circuit breaker is tripped according to an embodiment of this disclosure.

### REFERENCE NUMERALS

100: circuit breaker; 200: inverter; 300: photovoltaic module; 400: load;
10: arc extinguishing assembly; 11: arc extinguishing unit; 111: arc extinguishing grid plate; 112: fastening plate; 12: arc guiding member; 121: arc guiding section; 122: extension section; 123: directional section; 1211: first structure end; 1212: second structure end; 20: busbar; 201: fastening part; 202: breakable part; 2021: broken section; 30: detonation assembly; 301: impact structure; 40: housing; 41: outer housing; 42: inner housing; 43: detonation housing; 401: bottom surface; 402: side surface; 403: top surface.

### DESCRIPTION OF EMBODIMENTS

A circuit breaker plays an important role in an electrical network. When a loop is normal, the circuit breaker is configured to connect a circuit. When the loop is abnormal, the circuit breaker is configured to disconnect the circuit. A conventional circuit breaker and fuse have slow short-circuit protection actions and large I²T values (where I²T is a ratio of an action time limit to a square of an input current) during disconnection, which cannot meet a distribution protection requirement in the new energy field.

Based on this, embodiments of this disclosure provide a circuit breaker and a photovoltaic system. The circuit breaker can efficiently and quickly extinguish an arc during disconnection, and may be applied to protection of a photovoltaic system with a high voltage.

To make objectives, technical solutions, and advantages of this disclosure clearer, the following further describes this disclosure in detail with reference to accompanying drawings. Terms used in the following embodiments are merely intended to describe specific embodiments, but are not intended to limit this disclosure. “One”, “a”, “the” and “this” of singular expression forms used in the specification and the appended claims of this disclosure are also intended to include expression forms such as “one or more”, unless otherwise specified in the context clearly.

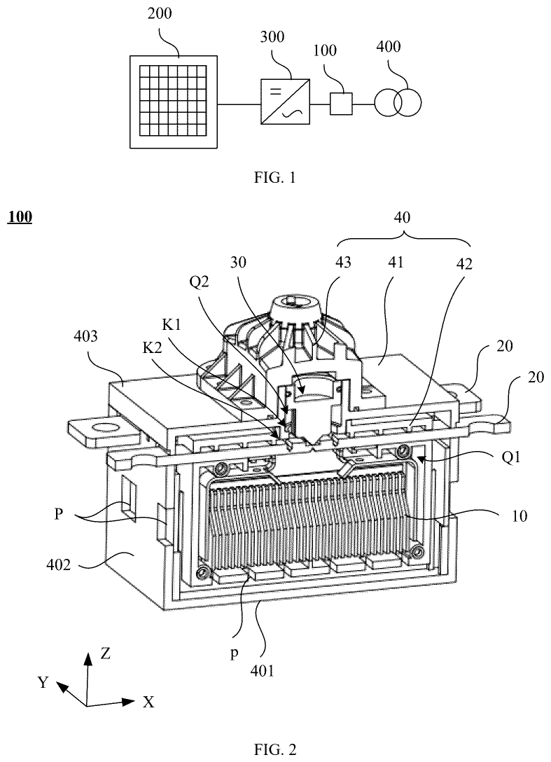

An embodiment of this disclosure provides a circuit breaker 100. The circuit breaker 100 may be disposed on an input side and/or an output side of any device in a distribution network, and is configured to quickly disconnect and protect a circuit when an electrical loop is abnormal. A photovoltaic system shown in FIG. 1 is used as an example. The photovoltaic system includes the circuit breaker 100 and an inverter 200. A direct current input of the inverter 200 is configured to connect to a photovoltaic module 300, an alternating current output of the inverter 200 is connected to the circuit breaker 100, and the circuit breaker 100 is configured to connect to a load 400. The load 400 may be a power grid, or may be an electric device, an energy storage device, or the like. A photovoltaic panel in the photovoltaic module 300 converts solar energy into electric energy and outputs a first voltage, and then converts the first voltage into a second voltage through an intelligent conversion module. After the photovoltaic module 300 outputs the second voltage, the inverter 200 in the photovoltaic system performs direct current (DC) to alternating current (AC) conversion (that is, DC/AC conversion) on the second voltage, and finally outputs an alternating current voltage, that is, a third voltage, to supply power to the electric device.

A structure of the circuit breaker 100 provided in this embodiment of this application is shown in FIG. 2. FIG. 2 shows an example of a cross-sectional structure of the circuit breaker 100. As shown in FIG. 2, the circuit breaker 100 includes a housing 40, a busbar 20, a detonation assembly 30, and an arc extinguishing assembly 10. For ease of description, a structure of the busbar 20 is used as a reference. A length direction of the busbar 20 is an X direction, a width direction of the busbar 20 is a Y direction, and a thickness direction of the busbar 20 is a Z direction. The housing 40 includes an outer housing 41, at least one inner housing 42, and at least one detonation housing 43. A plurality of inner housings 42 are accommodated in the outer housing 41, each inner housing 42 encloses to form one arc extinguishing chamber Q1, and the arc extinguishing assembly 10 is accommodated in the arc extinguishing chamber Q1. The outer housing 41 is, for example, cubic in shape, and an outer surface of the outer housing 41 includes a bottom surface 401, side surfaces 402, and a top surface 403. The bottom surface 401 and the top surface 403 are opposite to each other along the Z direction, and the bottom surface 401 may be configured to be fastened to another structure, to implement installation and fastening of the outer housing 41. The side surface 402 is connected between the bottom surface 401 and the top surface 403 in a surrounding manner, and two opposite sockets T are provided on the side surfaces 402. The detonation housing 43 is fastened to the top surface 403, and the detonation housing 43 encloses to form a detonation chamber Q2. An opening K1 is provided on the top surface 403 of the outer housing 41, the inner housing 42 communicates with the opening K1 through a communicating port K2, the detonation housing 43 also communicates with the opening K1, and the arc extinguishing chamber Q1 and the detonation chamber Q2 may communicate with each other through the opening K1. The busbar 20 passes through the housing 40, and two ends of the busbar 20 extend out of the housing 40, so that the two ends of the busbar 20 may be connected to an electrical circuit. The busbar 20 may be inserted into the housing 40 through the two sockets T on the side surfaces 402, and the busbar 20 sequentially passes through the outer housing 41 and the inner housing 42, so that the busbar 20 is partially located in the arc extinguishing chamber Q1. Along the Z direction, an orthographic projection of the opening K1 on the outer housing 41 and an orthographic projection of the busbar 20 on the outer housing 41 at least partially overlap. In other words, a part of the structure of the busbar 20 is located between the detonation chamber Q2 and the arc extinguishing chamber Q1. When a current flowing through the busbar 20 is greater than a safety threshold, the detonation assembly 30 explodes, an impact force generated by the explosion may pass through the opening K1 and rush to the busbar 20, and the impact force of the explosion may break the busbar 20, leading to a power outage. After the busbar 20 is broken, an arc generated between breaks may enter the arc extinguishing chamber Q1, and the arc extinguishing assembly 10 can extinguish the arc.

The arc extinguishing assembly 10 generates high-temperature and high-pressure gas during arc extinguishing. To exhaust the gas generated during arc extinguishing, still referring to FIG. 2, the outer housing 41 is provided with an exhaust vent P, and the exhaust vent P penetrates the outer housing 41. An internal channel for communicating the exhaust vent P and the arc extinguishing chamber Q1 is formed between the inner housing 42 and the outer housing 41. The inner housing 42 may be installed in the outer housing 41 by using another mechanical member. A gap exists between the inner housing 42 and the outer housing 41, and the gap can form a part of the internal channel. For example, the exhaust vent P is provided on the side surface 402, which does not affect installation and fastening of the outer housing 41, and can shorten an exhaust path as much as possible. Herein, there are two exhaust vents P, and the two exhaust vents P are symmetrical or approximately symmetrical along an extension direction of the X direction.

To exhaust the gas in the arc extinguishing chamber Q1 as soon as possible, a plurality of air passages p may be provided on a side that is of the inner housing 42 and that faces the bottom surface 401. The plurality of air passages p are equivalent to a part of the internal channel, and the air passage p communicates the arc extinguishing chamber Q1 with the gap between the inner housing 42 and the outer housing 41. There are a plurality of air passages p, which can improve an exhaust speed. For example, the plurality of air passages p may be evenly provided in a distributed manner, to be specific, may be evenly provided along a direction perpendicular to the Z direction, to improve uniformity of gas exhaust from the arc extinguishing chamber Q1, and maintain uniformity of the gas in the arc extinguishing chamber Q1. A shape of the air passage p and a quantity of air passages p are not limited, and may be set based on a shape of the arc extinguishing chamber Q1 and an exhaust requirement.

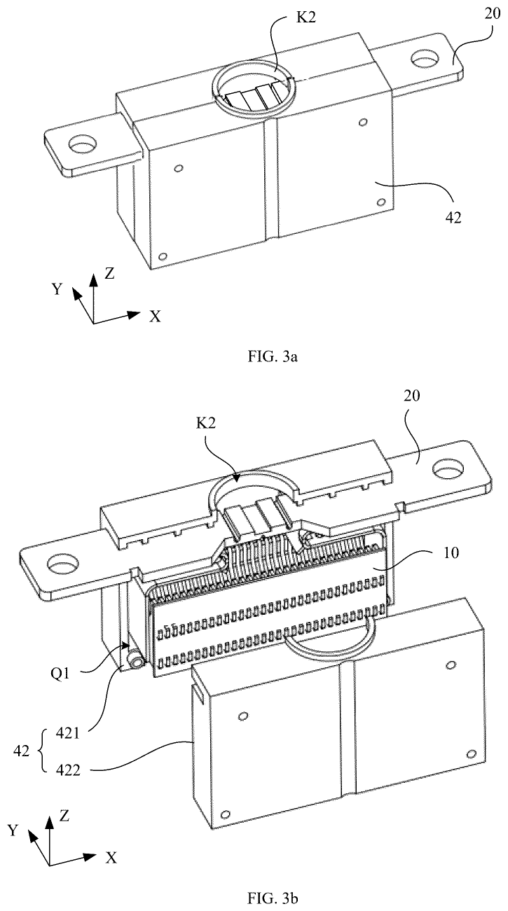

As shown in FIG. 3a and FIG. 3b, one busbar 20 may be correspondingly disposed for each inner housing 42, and the busbar 20 passes through the inner housing 42. The inner housing 42 has a communicating port K2, and at least a part of a structure of the busbar 20 in the arc extinguishing chamber Q1 may be exposed at the communicating port K2. When the inner housing 42 is accommodated in the outer housing 41, the communicating port K2 communicates with the opening K1 of the outer housing 41, so that the arc extinguishing chamber Q1 can communicate with the opening K1 through the communicating port K2. FIG. 3b is an exploded view of a part of structures of the inner housing 42 and the busbar 20. The inner housing 42 is, for example, cubic in shape. Along the Y direction, the inner housing 42 may be formed by splicing a first housing 421 and a second housing 422.

An arc generated by breakage of each busbar 20 may be extinguished by an arc extinguishing assembly 10 in a corresponding arc extinguishing chamber Q1. The arc extinguishing chamber Q1 of each inner housing 42 may correspondingly communicate with a detonation chamber Q2 of one detonation housing 43 in a one-to-one manner, in other words, the breakage of each busbar 20 may be completed by explosive impact of a uniquely corresponding detonation assembly 30. Alternatively, arc extinguishing chambers Q1 of a plurality of inner housings 42 may communicate with a detonation chamber Q2 of a same detonation housing 43, in other words, breakage of a plurality of busbars 20 may be completed by explosive impact of a same detonation assembly 30.

When two or more inner housings 42 are accommodated in one outer housing 41, each inner housing 42 and one arc extinguishing assembly 10 may form an arc extinguishing modular structure, and each arc extinguishing modular structure may correspond to one busbar 20, to perform arc extinguishing when the corresponding busbar 20 is broken. The circuit breaker 100 may be formed by assembling such modular structures, so that a structure is simpler, and automated assembly is easily implemented. When one arc extinguishing modular structure is disposed in the circuit breaker 100, a single-pole switch can be formed. When a plurality of arc extinguishing modular structures are disposed in the circuit breaker 100, a multi-pole switch can be formed, and insulation isolation is easily implemented between poles, so that device security and reliability can be improved.

The circuit breaker 100 provided in this embodiment of this disclosure is a detonation switch. The detonation switch uses energy generated by explosion of an ignition device to break the busbar, to disconnect the circuit. This has an advantage of fast protection action, and can implement active protection and passive protection in a full current range. In addition, an I²T value during disconnection is small. Therefore, safety of the distribution network can be improved.

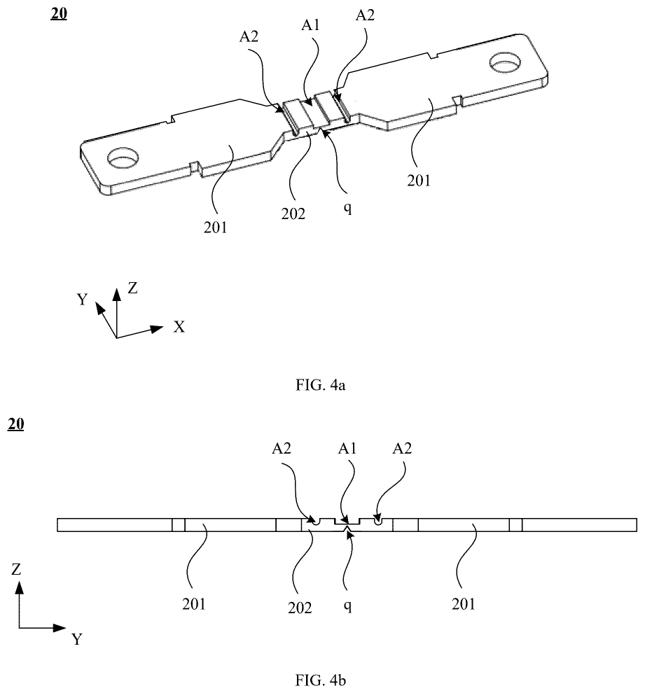

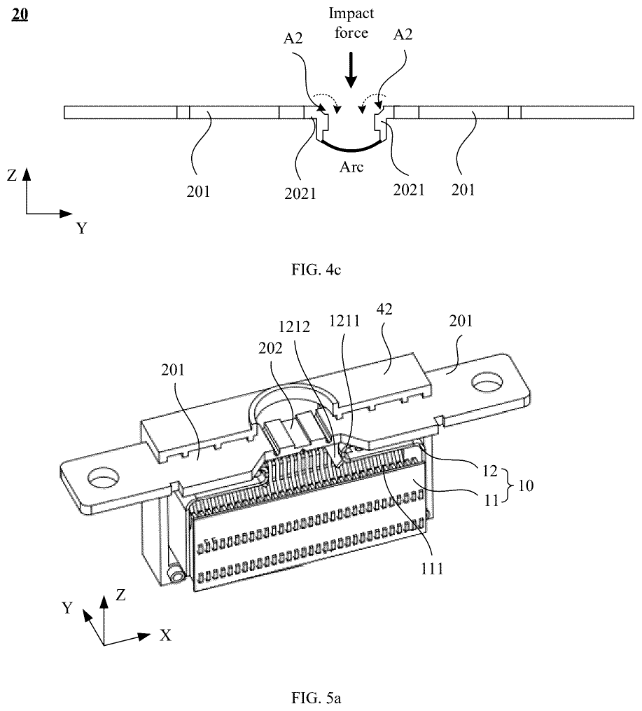

FIG. 4a shows an example of the structure of the busbar 20. As shown in FIG. 4a, the busbar 20 includes two fastening parts 201 and a breakable part 202 connected between the two fastening parts 201, and the two fastening parts 201 and the breakable part 202 are of an integrally connected structure. For example, along the X direction, the two fastening parts 201 are symmetrically distributed relative to the breakable part 202. Along the Y direction, a size of the breakable part 202 is less than a size of the fastening part 201, in other words, a width of the breakable part 202 is less than a width of the fastening part 201, so that structural strength of the breakable part 202 is less than structural strength of the fastening part 201. Referring to FIG. 2 and FIG. 3a, when the busbar 20 is installed in the housing 40, the breakable part 202 is located between the arc extinguishing chamber Q1 and the detonation chamber Q2. The breakable part 202 corresponds to the opening K1 along the Z direction. When the explosive impact force strikes the busbar 20, the impact force can be applied to the breakable part 202, to improve reliability and a speed of disconnecting the circuit.

Still referring to FIG. 4a, the breakable part 202 includes a first groove A1 and a notch q that are provided in the middle of the breakable part 202. Along the Z direction, the first groove A1 and the notch q are respectively provided on two surfaces of the breakable part 202, and extension directions of the first groove A1 and the notch q are both parallel to the Y direction. The first groove A1 is opposite to the notch q along the Z direction, and an orthographic projection of the notch q along the Z direction on a surface that is of the busbar 20 and on which the first groove A1 is provided falls within the first groove A1. A second groove A2 is provided at a joint between the breakable part 202 and the fastening part 201. Along the Z direction, the first groove A1 and the second groove A2 are provided on a same side of the busbar 20, and an extension direction of the second groove A2 is also parallel to the Y direction. The breakable part 202 has the first groove A1 and the notch q, and the joint between the breakable part 202 and the fastening part 201 has the second groove A2. Along the Z direction, a distance between a groove bottom of the first groove A1 and a bottom of the notch q is less than a distance between a groove bottom of the second groove A2 and another surface of the busbar 20, so that strength of the notch q of the breakable part 202 is less than strength of the joint between the breakable part 202 and the fastening part 201.

FIG. 4b is a view of the busbar 20 along the Y direction. As shown in FIG. 4b, a cross section that is of the first groove A1 and that is perpendicular to the Y direction is a rectangle, and the first groove A1 can form large space on the surface of the busbar 20. A cross section that is of the notch q and that is perpendicular to the Y direction is a triangle, and the bottom of the notch q is a straight line that is approximately parallel to the Y direction, so that the breakable part 202 can be broken along the bottom of the notch q. In this case, a breaking speed is fast, and a break is neat. Along the X direction, a size of the first groove A1 is greater than a size of the notch q. The first groove A1 and the notch q can reduce structural strength of the breakable part 202 along the Z direction. When the busbar 20 is installed in the housing 40, along the Z direction, the first groove A1 faces the detonation chamber Q2, and the notch q faces the arc extinguishing chamber Q1. Along the X direction, a size of the second groove A2 is less than the size of the first groove A1, and the groove bottom of the second groove A2 has an arcuate surface. Existence of the second groove A2 reduces the strength of the joint between the breakable part 202 and the fastening part 201 along the Z direction. Along the Z direction, the strength of the joint between the breakable part 202 and the fastening part 201 is less than strength of the fastening part 201.

When the detonation assembly 30 explodes, the generated impact force is applied to the first groove A1, and the large space of the first groove A1 can bear the impact force. The impact force breaks the breakable part 202 into two broken sections 2021, and the breakable part 202 is broken along the notch q, forming a structure shown in FIG. 4c. Each broken section 2021 is connected to the fastening part 201, and the broken section 2021 is bent at the second groove A2 relative to the fastening part 201 along a direction shown by a dashed line. The two broken sections 2021 of the breakable part 202 are disconnected, and an arc is formed between the two broken sections 2021. The arc extinguishing assembly 10 in this embodiment of this disclosure is configured to extinguish the arc.

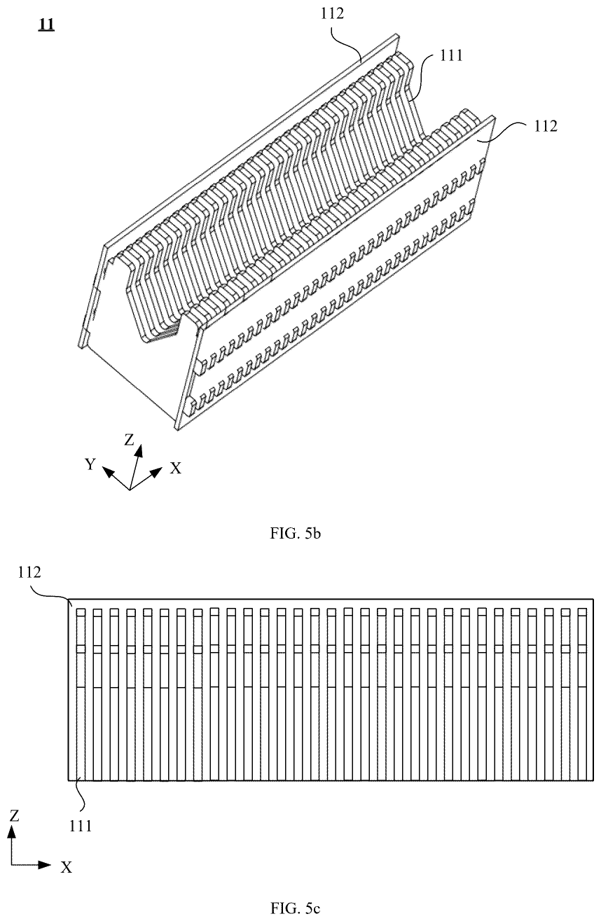

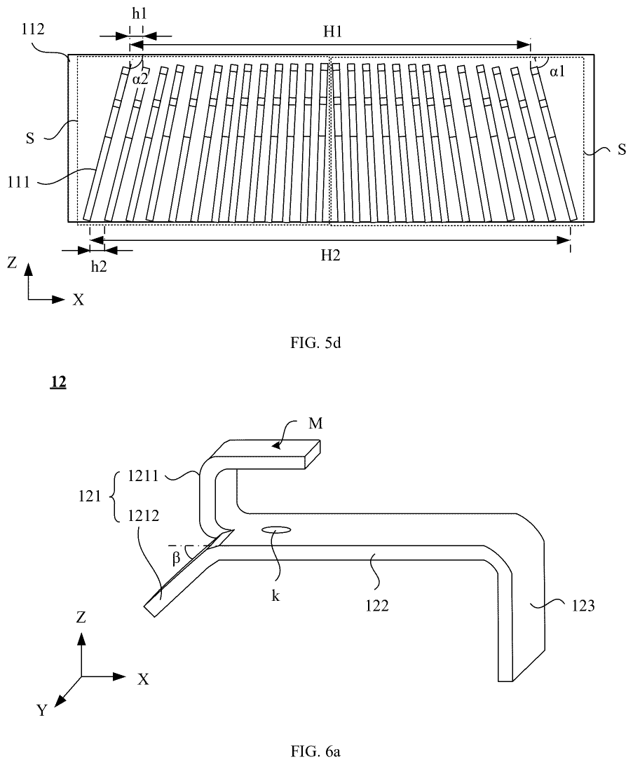

As shown in FIG. 5a, the arc extinguishing assembly 10 includes an arc extinguishing unit 11 and two arc guiding members 12. The arc extinguishing unit 11 includes a plurality of arc extinguishing grid plates 111, and the plurality of arc extinguishing grid plates 111 are arranged at intervals along the X direction. Along the X direction, the plurality of arc extinguishing grid plates 111 include the first arc extinguishing grid plate and the last arc extinguishing grid plate, and the first arc extinguishing grid plate and the last arc extinguishing grid plate are two arc extinguishing grid plates 111 at two ends of the arc extinguishing unit 11 along the X direction. It can be learned from the foregoing embodiment that the breakable part 202 is broken to form two breaks, and the arc is formed between the two breaks. The two arc guiding members 12 are arranged along the X direction and distributed symmetrically. The two arc guiding members 12 are separately a first arc guiding member and a second arc guiding member. It is set that the first arc guiding member is configured to guide an arc root of the arc to a position near the first arc extinguishing grid plate 111, and the second arc guiding member is configured to guide an arc root of the arc to a position near the last arc extinguishing grid plate 111. The first arc guiding member may guide an arc root at one end of the arc to the first arc extinguishing grid plate of the plurality of arc extinguishing grid plates 111, and the second arc guiding member may guide an arc root at the other end of the arc to the last arc extinguishing grid plate of the plurality of arc extinguishing grid plates 111, so that the arc may enter between the plurality of arc extinguishing grid plates 111 and be interrupted by the plurality of arc extinguishing grid plates 111, to implement arc extinguishing. Alternatively, the arc extinguishing assembly 10 may include only a first arc guiding member or a second arc guiding member. The first arc guiding member and the second arc guiding member have a same shape. Therefore, the arc guiding member 12 is used for description.

For example, the arc guiding member 12 is a strip-shaped bent structure. Along an extension direction of the busbar 20, a first end of the arc guiding member 12 includes a first structure end 1211, the first structure end 1211 is in conductive contact with the busbar 20, and a second end of the arc guiding member 12 extends to the arc extinguishing unit 11. The first end of the arc guiding member 12 further includes a second structure end 1212, and the second structure end 1212 is bent in a direction close to the arc extinguishing unit 11.

FIG. 5b shows an example of a structure of the arc extinguishing unit 11. As shown in FIG. 5b, the plurality of arc extinguishing grid plates 111 are arranged along the X direction, and any two adjacent arc extinguishing grid plates 111 are disposed in an insulated manner. For example, the arc extinguishing unit 11 further includes two insulating fastening plates 112 that are opposite to each other along the Y direction, the two insulating fastening plates 112 are parallel to each other, and the plurality of arc extinguishing grid plates 111 are arranged between the two insulating fastening plates 112. As shown in FIG. 5b, two ends of each arc extinguishing grid plate 111 are respectively fastened to the two insulating fastening plates 112 along the Y direction. Along the X direction, any two arc extinguishing grid plates 111 are not in contact with each other, to implement insulation.

FIG. 5c is a diagram of a structure of the arc extinguishing unit 11 in FIG. 5b observed along the Y direction. As shown in FIG. 5c, each arc extinguishing grid plate 111 is in a flat plate shape perpendicular to the X direction, in other words, each arc extinguishing grid plate 111 is perpendicular to an arrangement direction of the plurality of arc extinguishing grid plates 111, and any two arc extinguishing grid plates 111 are parallel to each other.

In some other embodiments, as shown in FIG. 5d, along the X direction, a part of arc extinguishing grid plates 111 are disposed at an acute clockwise angle α1 to the X direction, and the other part of arc extinguishing grid plates 111 are disposed at an obtuse clockwise angle α2 to the X direction. Along the extension direction of the busbar 20, that is, the X direction, a distance H1 between an end part that is of the first arc extinguishing grid plate 111 and that faces the busbar 20 and an end part that is of the last arc extinguishing grid plate 111 and that faces the busbar 20 is less than a distance H2 between an end part that is of the first arc extinguishing grid plate 111 and that is away from the busbar 20 and an end part that is of the last arc extinguishing grid plate 111 and that is away from the busbar 20. For example, along the X direction, the plurality of arc extinguishing grid plates 111 are distributed in an axisymmetric manner. In FIG. 5d, along the X direction, the plurality of arc extinguishing grid plates 111 are divided into two parts shown in dashed-line boxes S, and quantities of arc extinguishing grid plates 111 in the dashed-line boxes S are the same. Arc extinguishing grid plates 111 located in a same dashed-line box S are inclined to a same side relative to the X direction, and structures shown in the two dashed-line boxes S are distributed in the axisymmetric manner. The plurality of arc extinguishing grid plates 111 shown in FIG. 5d are inclined. When the arc extinguishing unit 11 is assembled into the inner housing 42, high-pressure gas generated during arc extinguishing by the arc extinguishing unit 11 is more easily guided to exhaust vents P on two sides. In addition, in this inclined arrangement manner of the plurality of arc extinguishing grid plates 111, the arc can be further elongated, interrupted, and extinguished, to achieve better arc extinguishing effect. It should be understood that, to facilitate gas guiding, the inclined arrangement manner of the plurality of arc extinguishing grid plates 111 of the arc extinguishing unit 11 may be adaptively adjusted based on positions of the exhaust vents P.

Further, along the extension direction of the busbar 20, in any two adjacent arc extinguishing grid plates 111, a distance h1 between end parts that are of the two arc extinguishing grid plates 111 and that face the busbar 20 is less than a distance h2 between end parts that are of the two arc extinguishing grid plates 111 and that are away from the busbar 20. As shown in FIG. 5d, along the X direction, from a center of the arc extinguishing unit 11 to an end part of the arc extinguishing unit 11, an included angle between the arc extinguishing grid plate 111 and the X direction gradually decreases. In a same dashed-line box S, in any two adjacent arc extinguishing grid plates 111, an included angle between the X direction and an arc extinguishing grid plate 111 close to the center of the arc extinguishing unit 11 is greater than an included angle between the X direction and an arc extinguishing grid plate 111 close to the end part of the arc extinguishing unit 11.

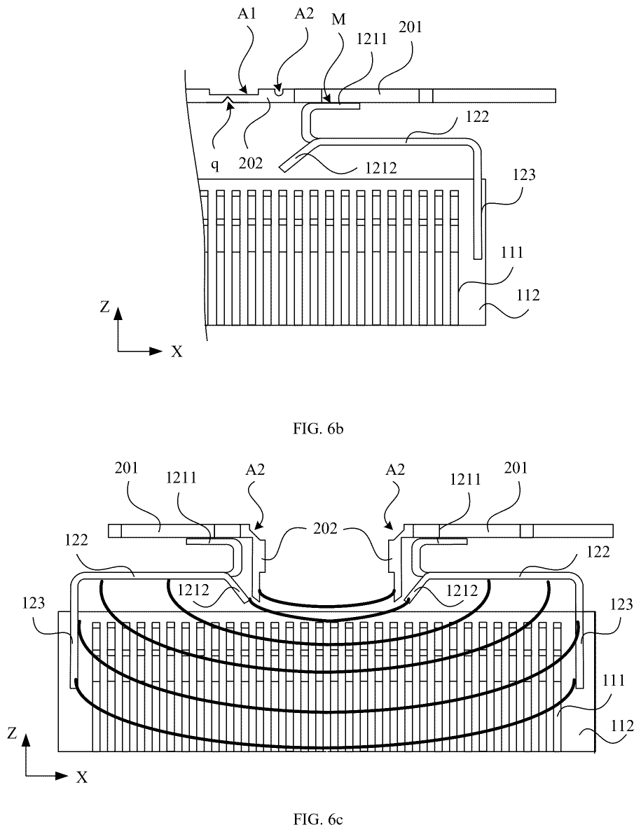

FIG. 6a shows an example of a structure of the arc guiding member 12. For the structure of the arc guiding member 12, a status of an actual connection between the busbar 20 and the arc extinguishing unit 11 is used as a reference. For ease of illustration, the arc guiding member 12 is divided into three sections, and the arc guiding member 12 includes an arc guiding section 121, an extension section 122, and a directional section 123. An end that is of the arc guiding section 121 and that is away from the extension section 122 is the first end of the arc guiding member 12, an end that is of the directional section 123 and that is away from the extension section 122 is the second end of the arc guiding member 12, and the extension section 122 is connected between the arc guiding section 121 and the directional section 123. For example, the arc guiding section 121 is bifurcated along the Y direction to form the first structure end 1211 and the second structure end 1212. Along the Z direction, the first structure end 1211 and the second structure end 1212 are bent in opposite directions. In FIG. 6a, the arc guiding member 12 has a mounting hole k, and a screw is in threaded connection to the busbar 20 after passing through the mounting hole k, so that the arc guiding member 12 can be fastened to the busbar 20. For example, the second structure end 1212 is bent in the direction close to the arc extinguishing unit 11, and an extension direction of the second structure end 1212 is set at an acute clockwise angle β to the busbar 20. When the busbar 20 is broken, the second structure end 1212 can be closer to the breakable part 202.

FIG. 6b shows an example of a structure in which the arc guiding member 12 connects the busbar 20 and the arc extinguishing unit 11 along the Y direction. As shown in FIG. 6b, the first structure end 1211 is bent in a direction away from the arc extinguishing unit 11, to be connected to the fastening part 201 of the busbar 20; and the second structure end 1212 is bent in the direction close to the arc extinguishing unit 11, to be close to the breakable part 202 after the busbar 20 is broken. When the arc guiding member 12 is the first arc guiding member configured to guide the arc to the first arc extinguishing grid plate, the directional section 123 is, for example, parallel to the first arc extinguishing grid plate and extends to an end that is of the first arc extinguishing grid plate and that is away from the busbar 20. When the arc guiding member 12 is the second arc guiding member configured to guide the arc to the last arc extinguishing grid plate, the directional section 123 is, for example, parallel to the last arc extinguishing grid plate and extends to the end that is of the last arc extinguishing grid plate and that is away from the busbar 20. The directional section 123 may guide the arc root of the arc to a bottom of the arc extinguishing grid plate 111, so that the arc can enter as deep as possible between the plurality of arc extinguishing grid plates 111.

There is a gap between the directional section 123 and the arc extinguishing grid plate 111, to achieve good arc extinguishing effect. The extension section 122 is connected between the arc guiding section 121 and the directional section 123, and the extension section 122 is approximately parallel to the arrangement direction of the plurality of arc extinguishing grid plates 111, to guide the arc from the arc guiding section 121 to the directional section 123.

For example, after the first structure end 1211 is bent, at least a part of a structure of the first structure end 1211 is approximately parallel to the arrangement direction of the plurality of arc extinguishing grid plates 111, that is, the X direction. The first structure end 1211 can be in contact with and connected to the fastening part 201 of the busbar 20 along the extension direction of the busbar 20.

In an embodiment, to enable the first structure end 1211 to be in more adequate contact with the fastening part 201 of the busbar 20, and ensure reliability of an electrical connection, with reference to FIG. 6a and FIG. 6b, a side that is of the first structure end H1 and that is away from the arc extinguishing unit 11 includes a contact surface M, and the contact surface M is parallel to the busbar 20. When the first structure end 1211 is connected to the fastening part 201 of the busbar 20, the contact surface M is closely attached to a surface that is of the fastening part 201 and that faces the arc extinguishing unit 11. The first structure end 1211 is in surface contact with and connected to the fastening part 201, so that there is a large contact area between the first structure end 1211 and the busbar 20, and the reliability of the electrical connection is higher. The first arc guiding member is used as an example. To guide the arc root of the arc to the first arc extinguishing grid plate, the second structure end 1212 is bent in the direction close to the arc extinguishing unit 11, and the extension direction of the second structure end 1212 is set at an included angle to the X direction. For example, an included angle between the second structure end 1212 and the extension section 122 is an obtuse angle, so that the second structure end 1212 can be closer to the breakable part 202 after the busbar 20 is broken. After the breakable part 202 of the busbar 20 is broken, the arc root of the arc formed between the breaks can be captured by the second structure end 1212 in time.

As shown in FIG. 6c, when the busbar 20 is broken by the explosive impact force, the breakable part 202 is bent toward the side of the arc extinguishing unit 11 under strong impact, and finally is approximately in a status shown in FIG. 6c, that is, perpendicular to the fastening part 201. In this case, an end that is of the breakable part 202 and that is away from the fastening part 201 is close to the second structure end 1212. An arc is generated between two breaks, and the arc may be gradually stretched along the X direction by traction of the two arc guiding members 12. As shown in FIG. 6c, the arc between the two breakable parts 202 is an initially formed arc. Under pulling of the two arc guiding members 12, two arc roots of the arc gradually move to two second structure ends 1212, two extension sections 122, and two directional sections 123. In this process, the arc gradually enters between the plurality of arc extinguishing grid plates 111, and the plurality of arc extinguishing grid plates 111 interrupt the arc under effect of an airflow and a magnetic field, to implement arc extinguishing. As the directional section 123 extends to a bottom end that is of the arc extinguishing grid plate 111 and that is away from the busbar 20, the two arc roots of the arc may extend to the bottom end that is of the arc extinguishing grid plate 111 and that is away from the busbar 20, so that the arc can enter as deep as possible between the plurality of arc extinguishing grid plates 111, to achieve better arc extinguishing effect. The arc root of the arc may also be guided into the second structure end 1212 through the breakable part 202 and guided to the arc guiding member 12. The first structure end 1211 is always in surface contact with the fastening part 201 of the busbar 20, to ensure that the arc root of the arc can at least be guided from the first structure end 1211 to the second end of the arc guiding member 12. When the second structure end 1212 cannot guide the arc or has poor arc guiding effect, the first structure end 1211 can ensure that the arc root of the arc is guided to the second end of the arc guiding member 12 in time, so that the arc enters between the plurality of arc extinguishing grid plates 111 to implement arc extinguishing.

It can be learned from the foregoing embodiment that, in the arc extinguishing assembly 10 provided in this embodiment of this disclosure, the arc guiding member 12 can provide, through the first structure end 1211 and the second structure end 1212, two arc guiding paths for the arc formed by breakage of the busbar 20, to guide the arc to the arc extinguishing assembly 10 more quickly and reliably, so that arc extinguishing effect is ensured, and alternating current or direct current arc extinguishing at a high voltage can be implemented.

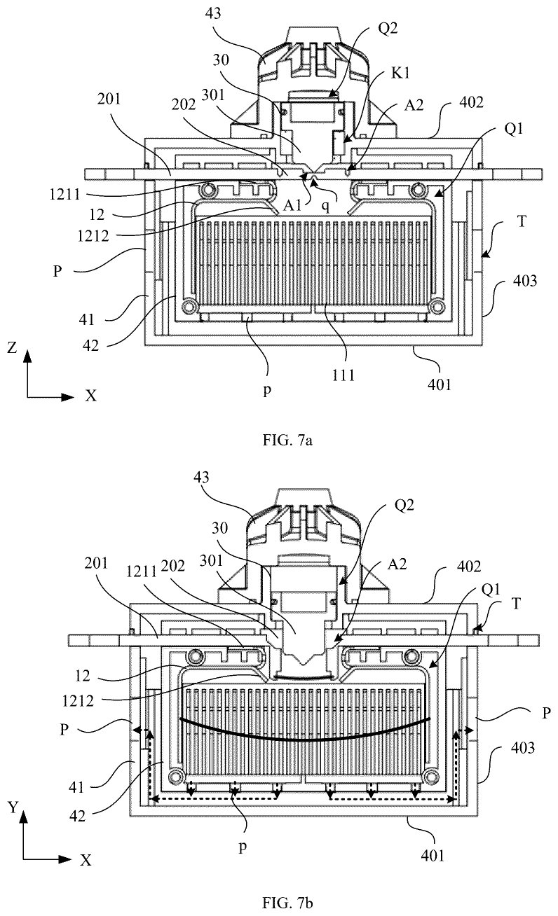

FIG. 7a is a diagram of a cross-sectional structure of the circuit breaker 100 observed along the Y direction. As shown in FIG. 7a, the detonation assembly 30 is accommodated in the detonation chamber Q2, the detonation chamber Q2 communicates with the arc extinguishing chamber Q1 through the opening K1, and the breakable part 202 of the busbar 20 is at least partially located between the detonation chamber Q2 and the arc extinguishing chamber Q1. The detonation assembly 30 includes an explosive and an impact structure 301, and the explosive is not shown herein. The impact structure 301 is partially accommodated in the detonation chamber Q2, and an end part of the impact structure 301 passes through the opening K1 and faces the breakable part 202 of the busbar 20. For example, an end that is of the impact structure 301 and that faces the busbar 20 is in a pointed shape. When the busbar 20 works normally, the end that is of the impact structure 301 and that faces the busbar 20 is close to or in contact with the first groove A1 of the breakable part 202 of the busbar 20. In this case, the arc guiding member 12 is connected between the busbar 20 and the arc extinguishing grid plate 111 of the arc extinguishing unit 11. The first structure end 1211 at the first end of the arc guiding member 12 is in surface contact with the fastening part 201 of the busbar 20, and the second structure end 1212 is bent toward a side of the plurality of arc extinguishing grid plates 111.

When the loop connected to the circuit breaker 100 is normal, the busbar 20 is configured to transmit a current. When the loop connected to the circuit breaker 100 is abnormal, the explosive of the detonation assembly 30 in the detonation chamber Q2 is ignited, and an impact force generated by explosion of the explosive ejects the impact structure 301 from the detonation chamber Q2 and flushes the impact structure 301 to the arc extinguishing chamber Q1. As shown in FIG. 7b, under the impact force, the impact structure 301 breaks, at the breakable part 202, the busbar 20 located between the detonation assembly 30 and the arc extinguishing assembly 10. The breakable part 202 is broken at the first groove A1 along the notch q, and is bent at the second groove A2 relative to the fastening part 201 toward the side of the arc extinguishing unit 11, to disconnect the electrical loop of the circuit breaker 100. When the busbar 20 is broken, the arc is generated between the two breaks of the breakable part 202. The two arc guiding members 12 may pull the arc to enter the plurality of arc extinguishing grid plates 111, and the plurality of arc extinguishing grid plates 111 interrupt and extinguish the arc. As shown by dashed-line arrows in FIG. 7b, high-temperature and high-pressure gas generated in a process in which the arc is extinguished between the plurality of arc extinguishing grid plates 111 may enter the gap between the inner housing 42 and the outer housing 41 through the plurality of air passages p, and be exhausted through the exhaust vent P.

Clearly, a person skilled in the art can make various modifications and variations to this disclosure without departing from the scope of this disclosure. This disclosure is intended to cover these modifications and variations of this disclosure provided that they fall within the scope of protection defined by the claims of this disclosure and their equivalent technologies.

What is claimed is:

1. A circuit breaker, comprising:
a housing comprising an arc extinguishing chamber and a detonation chamber coupled with each other;
a busbar passing through the housing and at least partially located between the arc extinguishing chamber and the detonation chamber;
a detonation assembly accommodated in the detonation chamber and configured to explode and break the busbar when a current flowing through the busbar is greater than a safety threshold; and
an arc extinguishing assembly accommodated in the arc extinguishing chamber, wherein the arc extinguishing assembly comprises a plurality of arc extinguishing grid plates arranged along an extension direction of the busbar and a first arc guiding member fastened to the busbar, and
wherein along the extension direction of the busbar, a first end of the first arc guiding member comprises a first structure end in conductive contact with the busbar, and a second end of the first arc guiding member extends to a first arc extinguishing grid plate that is along the extension direction of the busbar among the plurality of arc extinguishing grid plates.

2. The circuit breaker according to claim 1, wherein the arc extinguishing assembly further comprises a second arc guiding member, a first end of the second arc guiding member comprises a first structure end in conductive contact with the busbar, and a second end of the second arc guiding member extends to the last arc extinguishing grid plate that is along the extension direction of the busbar among the plurality of arc extinguishing grid plates.

3. The circuit breaker according to claim 1, wherein the first structure end comprises a contact surface facing away from the plurality of arc extinguishing grid plates, the contact surface is parallel to the extension direction of the busbar, and the contact surface is configured to connect the busbar.

4. The circuit breaker according to claim 1, wherein the first end of the first arc guiding member comprises a second structure end bent in a direction close to the first arc extinguishing grid plate, and an extension direction of the second structure end is set at an acute clockwise angle to the busbar.

5. The circuit breaker according to claim 1, wherein the first arc guiding member comprises an arc guiding section, an extension section, and a directional section that are integrally connected, and the extension section is connected between the arc guiding section and the directional section;
an end that is of the arc guiding section and that is away from the extension section is the first end of the first arc guiding member, and an end that is of the directional section and that is away from the extension section is the second end of the first arc guiding member; and
the extension section is parallel to the extension direction of the busbar, and the directional section extends in a direction of the first arc extinguishing grid plate away from the busbar.

6. The circuit breaker according to claim 1, wherein a part of arc extinguishing grid plates is disposed at an acute clockwise angle to the busbar, and another part of arc extinguishing grid plates is disposed at an obtuse clockwise angle to the busbar; and
along the extension direction of the busbar, a distance between an end part that is of the first arc extinguishing grid plate and that faces the busbar and an end part that is of the last arc extinguishing grid plate and that faces the busbar is less than a distance between an end part that is of the first arc extinguishing grid plate and that is away from the busbar and an end part that is of the last arc extinguishing grid plate and that is away from the busbar.

7. The circuit breaker according to claim 6, wherein along the extension direction of the busbar, in any two adjacent arc extinguishing grid plates, a distance between end parts that are of the two arc extinguishing grid plates and that face the busbar is less than a distance between end parts that are of the two arc extinguishing grid plates and that face away from the busbar.

8. The circuit breaker according to claim 1, wherein the housing further comprises:
an outer housing; and
a plurality of inner housings accommodated in the outer housing, wherein each inner housing encloses to form one arc extinguishing chamber, and one arc extinguishing assembly and one busbar are correspondingly disposed for each arc extinguishing chamber.

9. The circuit breaker according to claim 8, wherein the housing further comprises a detonation housing fastened to the outer housing, the detonation housing encloses to form one detonation chamber that communicates with at least one arc extinguishing chamber.

10. The circuit breaker according to claim 1, wherein the housing further comprises:
an exhaust vent that communicates with outside; and
a plurality of air passages disposed in a distributed manner, wherein each air passage communicates with the arc extinguishing chamber and the exhaust vent.

11. The circuit breaker according to claim 1, wherein the busbar comprises:
two fastening parts separately fastened to the housing; and
a breakable part located between the two fastening parts and is integrally connected to the two fastening parts, wherein the breakable part is located between the arc extinguishing chamber and the detonation chamber, and structural strength of the breakable part is less than structural strength of the fastening part.

12. A photovoltaic system, comprising:
a circuit breaker, comprising:
a housing comprising an arc extinguishing chamber and a detonation chamber coupled with each other;
a busbar passing through the housing and at least partially located between the arc extinguishing chamber and the detonation chamber;
a detonation assembly accommodated in the detonation chamber and configured to explode and break the busbar when a current flowing through the busbar is greater than a safety threshold; and
an arc extinguishing assembly accommodated in the arc extinguishing chamber, wherein the arc extinguishing assembly comprises a plurality of arc extinguishing grid plates arranged along an extension direction of the busbar and a first arc guiding member fastened to the busbar, and
wherein along the extension direction of the busbar, a first end of the first arc guiding member comprises a first structure end in conductive contact with the busbar, and a second end of the first arc guiding member extends to a first arc extinguishing grid plate that is along the extension direction of the busbar among the plurality of arc extinguishing grid plates; and
an inverter, wherein a direct current input of the inverter is configured to connect to a photovoltaic module, an alternating current output of the inverter is connected to the circuit breaker, and the circuit breaker is configured to connect to a load.

13. The photovoltaic system according to claim 12, wherein the arc extinguishing assembly comprises a second arc guiding member, a first end of the second arc guiding member comprises a first structure end in conductive contact with the busbar, and a second end of the second arc guiding member extends to the last arc extinguishing grid plate that is along the extension direction of the busbar among the plurality of arc extinguishing grid plates.

14. The photovoltaic system according to claim 12, wherein the first structure end comprises a contact surface facing away from the plurality of arc extinguishing grid plates, the contact surface is parallel to the extension direction of the busbar, and the contact surface is configured to connect the busbar.

15. The photovoltaic system according to claim 12, wherein the first end of the first arc guiding member further comprises a second structure end bent in a direction close to the first arc extinguishing grid plate, and an extension direction of the second structure end is set at an acute clockwise angle to the busbar.

16. The photovoltaic system according to claim 12, wherein the first arc guiding member comprises an arc guiding section, an extension section, and a directional section that are integrally connected, and the extension section is connected between the arc guiding section and the directional section;
an end that is of the arc guiding section and that is away from the extension section is the first end of the first arc guiding member, and an end that is of the directional section and that is away from the extension section is the second end of the first arc guiding member; and
the extension section is parallel to the extension direction of the busbar, and the directional section extends in a direction of the first arc extinguishing grid plate away from the busbar.

17. The photovoltaic system according to claim 12, wherein a part of arc extinguishing grid plates is disposed at an acute clockwise angle to the busbar, and another part of arc extinguishing grid plates is disposed at an obtuse clockwise angle to the busbar; and
along the extension direction of the busbar, a distance between an end part that is of the first arc extinguishing grid plate and that faces the busbar and an end part that is of the last arc extinguishing grid plate and that faces the busbar is less than a distance between an end part that is of the first arc extinguishing grid plate and that is away from the busbar and an end part that is of the last arc extinguishing grid plate and that is away from the busbar.

18. The photovoltaic system according to claim 17, wherein along the extension direction of the busbar, in any two adjacent arc extinguishing grid plates, a distance between end parts that are of the two arc extinguishing grid plates and that face the busbar is less than a distance between end parts that are of the two arc extinguishing grid plates and face away from the busbar.

19. The photovoltaic system according to claim 18, wherein the housing further comprises:
an outer housing; and
a plurality of inner housings accommodated in the outer housing, wherein each inner housing encloses to form one arc extinguishing chamber, and one arc extinguishing assembly and one busbar are correspondingly disposed for each arc extinguishing chamber.

20. The photovoltaic system according to claim 19, wherein the housing further comprises a detonation housing fastened to the outer housing, the detonation housing encloses to form one detonation chamber, and each detonation chamber communicates with at least one arc extinguishing chamber.
